(19) United States
(12) Patent Application Publication
(10) Pub. No.: US 2026/0302480 A1
(43) Pub. Date: Oct. 1, 2026

(54) BATTERY MODULE

(71) Applicant: HONDA MOTOR CO., LTD., Tokyo (JP)

(72) Inventors: Tatsuya SEKI, Saitama (JP); Hidemasa USUI, Saitama (JP); Kazutaka SUZUKI, Saitama (JP); Hirokazu WATANABE, Saitama (JP); Anri ISHIDE, Saitama (JP); Mahiro SAWADA, Saitama (JP); Yosuke YOSHIZAWA, Saitama (JP); Kenji TSUKAHARA, Saitama (JP)

(21) Appl. No.: 19/630,783

(22) Filed: Mar. 27, 2026

(30) Foreign Application Priority Data
Mar. 31, 2025 (JP) 2025-060066

(51) Int. Cl. H01M 50/242; H01M 4/38; H01M 50/209; H01M 50/291; H01M 50/293

(52) U.S. Cl. CPC H01M 50/242; H01M 4/382; H01M 50/209; H01M 50/291; H01M 50/293

(57) ABSTRACT

Provided is a battery module including: a battery cell stack in which a plurality of battery cells are stacked; and an elastic member disposed between the plurality of battery cells. The elastic member includes: a pouch including a first sealing part and a second sealing part at both end portions, respectively, thereof in a direction perpendicular to a stacking direction of the battery cells, the pouch having a gas sealed therein; a first support member supporting at least a portion of the first sealing part; and a second support member supporting at least a portion of the second sealing part. A ratio of a thickness of the first support member to a thickness of the pouch and a ratio of a thickness of the second support member to the thickness of the pouch are 0.2 or more and 3.5 or less.

This application is based on and claims the benefit of priority from Japanese Patent Application No. 2025-060066, filed on 31 Mar. 2025, the content of which is incorporated herein by reference.

### BACKGROUND OF THE INVENTION

### Field of the Invention

The present invention relates to a battery module.

### Related Art

In recent years, research and development has been conducted on battery modules that contribute to energy efficiency in order to ensure that more people have access to affordable, reliable, sustainable, and advanced energy.

Japanese Unexamined Patent Application, Publication No. 2003-303579 discloses a module containing a flat secondary battery. At this time, the module is formed by disposing a fluid-containing bag hermetically containing a fluid between a module outer casing for pressurizing and fixing the flat secondary battery and the flat secondary battery.

Patent Document 1: Japanese Unexamined Patent Application, Publication No. 2003-303579

### SUMMARY OF THE INVENTION

However, when the fluid-containing bag disclosed in Japanese Unexamined Patent Application, Publication No. 2003-303579 is disposed between a plurality of battery cells, positional displacement of the fluid-containing bag in a direction perpendicular to the stacking direction of the battery cells is likely to occur.

An object of the present invention is to provide a battery module capable of suppressing positional displacement of an elastic member in a direction perpendicular to a stacking direction of battery cells.

A first aspect of the present invention is a battery module including: a battery cell stack in which a plurality of battery cells are stacked; and an elastic member disposed between the plurality of battery cells. The elastic member includes: a pouch including a first sealing part and a second sealing part at both end portions, respectively, thereof in a direction perpendicular to a stacking direction of the battery cells, the pouch having a gas sealed therein; a first support member supporting at least a portion of the first sealing part; and a second support member supporting at least a portion of the second sealing part. A ratio of a thickness of the first support member to a thickness of the pouch and a ratio of a thickness of the second support member to the thickness of the pouch are 0.2 or more and 3.5 or less.

In a second aspect of the present invention according to the first aspect, in the direction perpendicular to the stacking direction of the battery cells, a length of the first support member and a length of the second support member are equal to or less than a length of the pouch.

In a third aspect of the present invention according to the first or second aspect, a seal strength of the first sealing part and a seal strength of the second sealing part are 1 N/mm or more.

In a fourth aspect of the present invention according to any one of the first to third aspects, in the first elastic member, a portion of the first sealing part and a portion of the second sealing part face the battery cells.

In a fifth aspect of the present invention according to any one of the first to fourth aspects, the pouch includes a third sealing part extending in the direction perpendicular to the stacking direction of the battery cells. The third sealing part faces one of the battery cells.

In a sixth aspect of the present invention according to the fifth aspect, the third sealing part includes a resin.

In a seventh aspect of the present invention according to the fifth aspect, the third sealing part includes a metal.

In an eighth aspect of the present invention according to any one of the first to seventh aspects, the first support member and the second support member each include a resin.

In a ninth aspect of the present invention according to any one of the first to seventh aspects, the first support member and the second support member each include a metal.

In a tenth aspect of the present invention according to any one of the first to ninth aspects, the pouch has an internal pressure of 0.1 MPa or more and 3.0 MPa or less.

In an eleventh aspect of the present invention according to any one of the first to tenth aspects, the elastic member further includes an elastic foam body disposed on each side of the pouch in the stacking direction of the battery cells.

In a twelfth aspects of the present invention according to any one of the first to eleventh aspects, the battery cells each include a cell including: a negative electrode material mixture layer including lithium metal or a lithium alloy; a solid electrolyte layer; and a positive electrode material mixture layer.

According to the present invention, it is possible to provide a battery module capable of suppressing positional displacement of an elastic member in a direction perpendicular to a stacking direction of battery cells.

### BRIEF DESCRIPTION OF THE DRAWINGS

FIG. 1 is a side view showing a battery module according to an embodiment of the present invention;

FIG. 2A is a partially enlarged perspective view of the battery module of FIG. 1;

FIG. 2B is a schematic diagram showing a cross section taken along line A-A of FIG. 2A;

FIG. 2C is a schematic diagram showing a cross section taken along line B-B of FIG. 2A;

FIG. 3A is a partially enlarged perspective view of a modification of the battery module of FIG. 2A;

FIG. 3B is a schematic diagram showing a cross section taken along line B-B of FIG. 3A; and

FIG. 4 is a schematic view showing a cross section of a modification of the battery module of FIG. 2B.

### DETAILED DESCRIPTION OF THE INVENTION

Hereinafter, embodiments of the present invention will be described with reference to the drawings.

### Battery Module

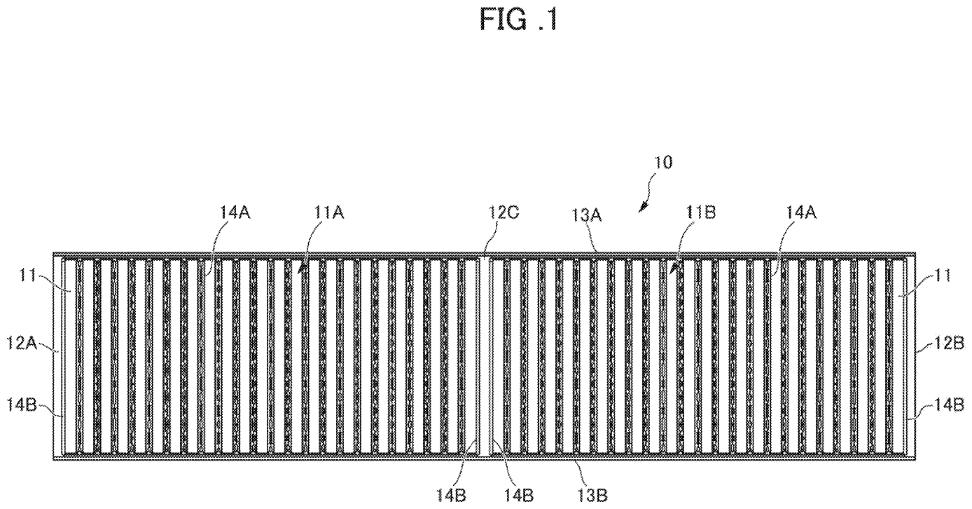

FIG. 1 shows a battery module according to an embodiment of the present invention.

A battery module 10 includes battery cell stacks 11A and 11B each including a plurality of battery cells 11 stacked, end plates 12A and 12B respectively provided at both end portions of the battery cell stacks 11A and 11B in the stacking direction, and a center plate 12C provided between the battery cell stacks 11A and 11B. The battery module 10 also includes binding bars 13A and 13B for restraining the battery cell stacks 11A and 11B between the end plates 12A and 12B. The restraining pressure by the binding bars 13A and 13B is not particularly limited, but is, for example, 0.1 MPa or more and 3.0 MPa or less.

In the battery module 10, a first elastic member 14A is disposed between each of the plurality of battery cells 11, and second elastic members 14B are respectively disposed between the battery cell stack 11A and the end plate 12A, between the battery cell stack 11A and the center plate 12C, between the battery cell stack 11B and the end plate 12B, and between the battery cell stack 11B and the center plate 12C. At this time, since the second elastic member 14B is in contact with one battery cell 11, it is not particularly limited as long as it has half or more of the elasticity of the first elastic member 14A in contact with two battery cells 11. The second elastic member 14B preferably has the same configuration as that of the first elastic member 14A except that the thickness is half from the viewpoint of the energy density of the battery module 10, but may be identical to the first elastic member 14A.

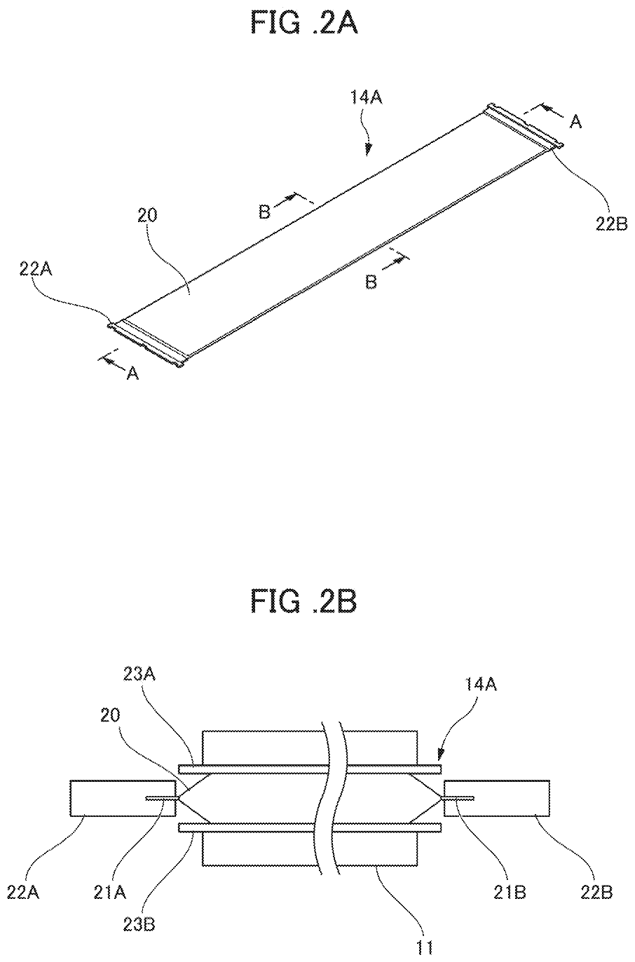

As shown in FIGS. 2A and 2B, the first elastic member 14A includes a pouch 20 which includes a first sealing part 21A and a second sealing part 21B at both end portions, respectively, in a longitudinal direction (A-A direction) perpendicular to the stacking direction of the battery cells 11, and in which a gas is sealed; a first support member 22A which supports the entire area of the first sealing part 21A; and a second support member 22B which supports the entire area of the second sealing part 21B. In FIG. 2A, the battery cells 11 and elastic foam bodies 23A and 23B described later are omitted.

At this time, the first support member 22A and the second support member 22B are positioned by, for example, a positioning member installed in the battery module 10.

The ratio of the thickness of the first support member 22A to the thickness of the pouch 20 and the ratio of the thickness of the second support member 22B to the thickness of the pouch 20 are 0.20 or more and 3.5 or less, preferably 0.30 or more and 3.0 or less, and more preferably 0.46 or more and 1.0 or less. When the ratio of the thickness of the first support member 22A to the thickness of the pouch 20 and the ratio of the thickness of the second support member 22B to the thickness of the pouch 20 are 0.20 or more and 3.5 or less, the pouch 20 can be disposed at an appropriate position, and as a result, positional displacement of the first elastic member 14A in the direction perpendicular to the stacking direction of the battery cells 11 is suppressed. At this time, the ratio of the thickness of the first support member 22A to the thickness of the pouch 20 and the ratio of the thickness of the second support member 22B to the thickness of the pouch 20 include a state in which the state of charge (SOC) is 0% and a state in which the SOC is 100%.

In order to properly operate the battery module 10, the overall length of the battery module 10 is determined by the thickness of the battery module 10. As the thickness of the pouch 20 is determined by the thickness of the battery module 10, the thickness of the first support member 22A and the thickness of the second support member 22B are also determined. At this time, it is preferable that the thickness of each of the first support member 22A and the second support member 22B is equal to or less than the sum of the thickness of the first support member 22A and the thickness of the second support member 22B.

In the longitudinal direction (A-A direction) perpendicular to the stacking direction of the battery cells 11, the length of the first support member 22A and the length of the second support member 22B are preferably equal to or less than the length of the pouch 20. As a result, positional displacement of the first elastic member 14A in the direction perpendicular to the stacking direction of the battery cells 11 is suppressed. At this time, the ratio of the length of the first support member 22A to the length of the pouch 20 and the ratio of the length of the second support member 22B to the length of the pouch 20 are preferably 0.001 or more and 0.05 or less, and more preferably 0.005 or more and 0.044 or less.

The seal strength of the first sealing part 21A and the seal strength of the second sealing part 21B are preferably 1 N/mm or more, more preferably 2 N/mm or more, and still more preferably 3 N/mm or more. When the seal strength of the first sealing part 21A and the seal strength of the second sealing part 21B are 1 N/mm or more, peeling of the first sealing part 21A and the second sealing part 21B is suppressed, and thus the durability of the battery module 10 is improved. The seal strength of the first sealing part 21A and the seal strength of the second sealing part 21B are, for example, 5 N/mm or less.

The seal strength is measured in accordance with JIS Z1701:2019.

As shown in FIG. 2B, the first elastic member 14A further includes elastic foam bodies 23A and 23B respectively disposed on both sides of the pouch 20 in the stacking direction of the battery cells 11. At this time, since the elastic foam bodies 23A and 23B are interposed between the battery cells 11 and the pouch 20 when the first elastic member 14A is compressed along with the expansion of the battery cells 11 during charging, the uniformity of the surface pressure of the first elastic member 14A is increased.

As shown in FIG. 2C, the pouch 20 includes a third sealing part 21C extending in the longitudinal direction (A-A direction) perpendicular to the stacking direction of the battery cells 11, and the third sealing part 21C faces the battery cell 11. Accordingly, since the third sealing part 21C is reinforced by the battery cell 11 and the elastic foam body 23B, the durability of the battery module 10 is improved. At this time, the third sealing part 21C is formed on one surface of the pouch 20 facing the battery cell 11, but may be formed on both surfaces of the pouch 20 facing the battery cells 11.

The pouch 20 is not particularly limited as long as it has stretchability that can follow the expansion and contraction accompanying the charging and discharging of the battery cells 11 and it is capable of sealing. For example, the pouch 20 may be a pouch in which an aluminum film is sandwiched between stretchable resin films. The stretchable resin is not particularly limited, and examples thereof include polypropylene, polyamide, and polyester.

The method for forming the first sealing part 21A, the second sealing part 21B, and the third sealing part 21C is not particularly limited, and examples thereof include a method of thermally fusing the stretchable resin constituting the pouch 20. The third sealing part 21C may be formed by metal welding. Accordingly, since the third sealing part 21C is reinforced, the durability of the battery module 10 is improved.

The internal pressure of the pouch 20 is preferably 0.1 MPa or more and 3.0 MPa or less, and more preferably 0.1 MPa or more and 2.5 MPa or less. When the internal pressure of the pouch 20 is 0.1 MPa or more, the uniformity of the surface pressure of the first elastic member 14A is increased, and when it is 3.0 MPa or less, even if the battery cells 11 expand and contract during charging and discharging of the battery cells 11, damage to the pouch 20 is more likely to be suppressed.

The pouch 20 is not particularly limited, and examples thereof include a pillow pouch (commercially available product). The gas sealed in the pouch 20 is not particularly limited, and examples thereof include air.

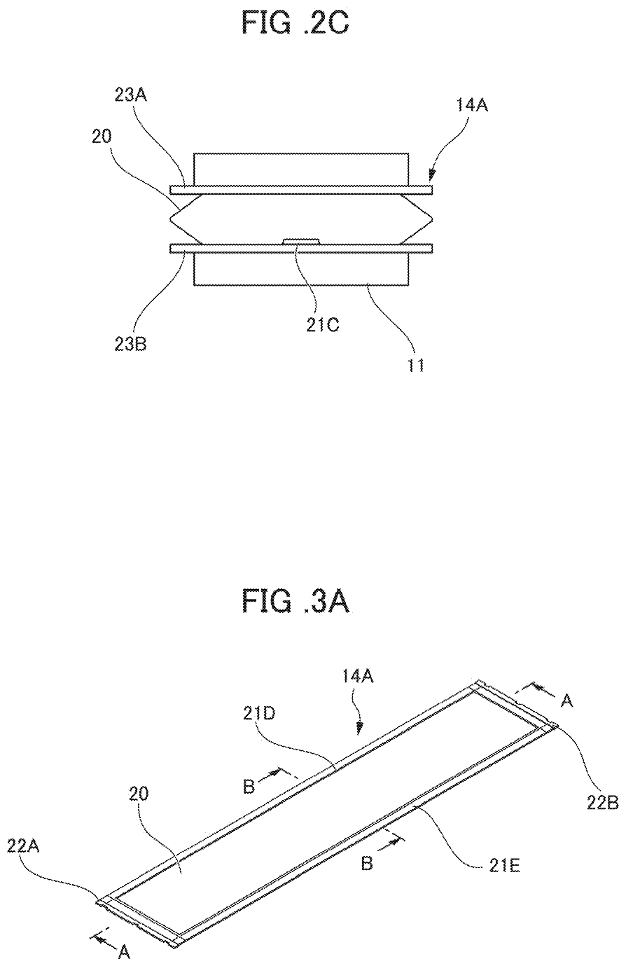

Instead of the pouch 20, a pouch including the first sealing part 21A and the second sealing part 21B at both end portions, respectively, in the longitudinal direction (A-A direction) perpendicular to the stacking direction of the battery cells 11 and including a sealing part other than the third sealing part 21C may be used. Specifically, a pouch (see FIGS. 3A and 3B) including the first sealing part 21A and the second sealing part 21B at both end portions, respectively, in the longitudinal direction (A-A direction) perpendicular to the stacking direction of the battery cells 11 and including a third sealing part 21D and a fourth sealing part 21E at both end portions, respectively, in a lateral direction (B-B direction) perpendicular to the stacking direction of the battery cells 11 may be used. Here, the seal strength of the first sealing part 21A, the second sealing part 21B, the third sealing part 21D, and the fourth sealing part 21E is, for example, 5 N/mm.

The material constituting the first support member 22A and the second support member 22B is not particularly limited. Among these, a resin is preferable from the viewpoint of the energy density of the battery module 10. On the other hand, from the viewpoint of durability of the battery module 10, metal is preferable.

The Poisson's ratio of the elastic foam bodies 23A and 23B is preferably 0.3 or less. When the Poisson's ratio of the elastic foam bodies 23A and 23B is 0.3 or less, the elastic foam bodies 23A and 23B easily absorb changes in thickness accompanying expansion and contraction of the battery cells 11. The Poisson's ratio of the elastic foam bodies 23A and 23B is, for example, 0.01 or more.

The thickness of the elastic foams 23A and 23B when the SOC of the battery cells is 100% is not particularly limited, but is, for example, 0.05 mm or more and 0.4 mm or less.

The porosity of the elastic foam bodies 23A and 23B is not particularly limited, but is, for example, 30% or more and 95% or less. The material constituting the elastic foam bodies 23A and 23B is not particularly limited, and examples thereof include polyurethane, silicone resin, ethylene propylene rubber, styrene resin, olefin resin, polyamide, and polyester.

The method for fixing the elastic foam bodies 23A and 23B to the pouch 20 is not particularly limited, and examples thereof include a method of bonding the elastic foam bodies 23A and 23B to the pouch 20 with an elastic adhesive.

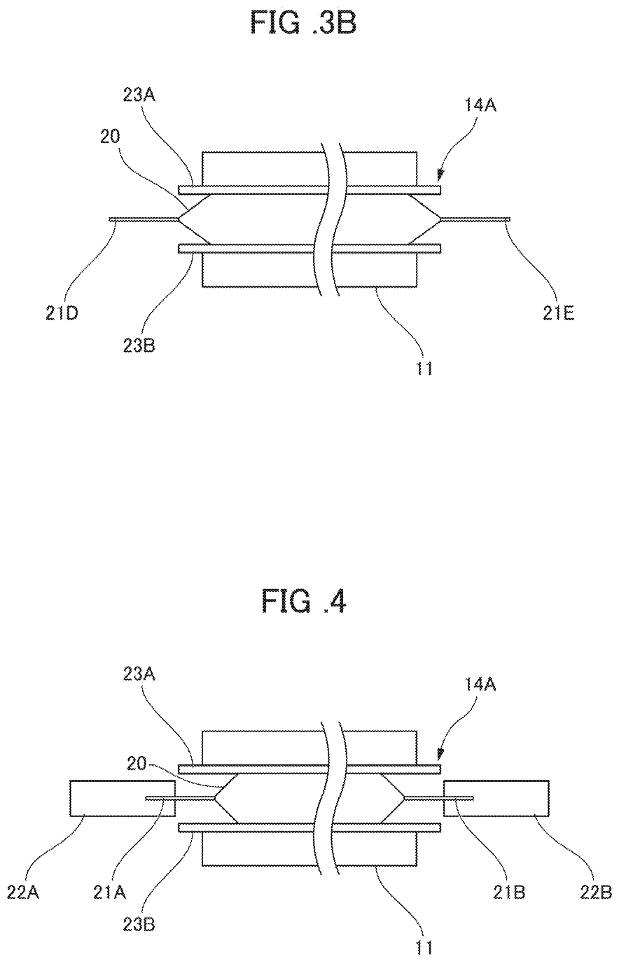

As shown in FIG. 4, in the first elastic member 14A, a portion of the first sealing part 21A and a portion of the second sealing part 21B may face the battery cells 11. This ensures uniform pressure across the entire surface of the pouch 20, thereby reducing stress concentration on the battery cell 11 side end portions of the first sealing part 21A and the second sealing part 21B, and improving the durability of the battery module 10. At this time, the ratio of the length of the portion of the first sealing part 21A (or the portion of the second sealing part 21B) facing the battery cells 11 to the length of the pouch 20 in the AA direction is not particularly limited, but is, for example, 0.001 or more and 0.005 or less.

### [Cell]

The cell constituting the battery cell 11 is not particularly limited, and examples thereof include a solid-state battery cell such as an all-solid-state battery cell or a semi-solid-state battery cell, and a nonaqueous electrolyte battery cell including a negative electrode material mixture layer containing lithium metal or a lithium alloy. An element other than lithium constituting the lithium alloy is not particularly limited, and examples thereof include Sn, Ag, Mg, In, Si, and Al. Among these, from the viewpoint of energy density, a cell including a negative electrode material mixture layer containing lithium metal or a lithium alloy, a solid electrolyte layer, and a positive electrode material mixture layer is preferable.

Hereinafter, an example of the all-solid-state battery cell will be described.

The all-solid-state battery cell includes a negative electrode current collector, a negative electrode material mixture layer containing lithium metal or a lithium alloy, a solid electrolyte layer, a positive electrode material mixture layer, and a positive electrode current collector. In general, all-solid-state battery cells are preferably applied to the battery module 10 because the pouch 20 tends to become displaced in the direction perpendicular to the stacking direction of the battery cells 11.

The material constituting the negative electrode current collector is not particularly limited, and examples thereof include silver, palladium, gold, platinum, aluminum, copper, nickel, stainless steel, and carbon. Among these, copper, stainless steel, and nickel are preferable from the viewpoints of conductivity and cost.

The shape of the negative electrode current collector is not particularly limited, and examples thereof include a foil shape, a plate shape, a mesh shape, a nonwoven fabric shape, and a foamed shape.

The solid electrolyte constituting the solid electrolyte layer is not particularly limited, and examples thereof include a sulfide solid electrolyte and an oxide solid electrolyte.

The form of the solid electrolyte is not particularly limited, and examples thereof include particles.

The content of the solid electrolyte in the solid electrolyte layer is not particularly limited, but is, for example, 50% by mass or more and 99% by mass or less.

The solid electrolyte layer may further contain a binder, etc.

The method for forming the solid electrolyte layer is not particularly limited, and examples thereof include a method of applying a slurry containing a solid electrolyte and a solvent.

The positive electrode material mixture layer contains a positive electrode active material. Examples of the positive electrode active material is not particularly limited, and examples thereof include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganate (LiMn₂O₄), Li₁₊ₓMn_{2-x-y}M_{y}O₄ (x+y=2) (where M is one or more elements selected from the group consisting of Al, Mg, Co, Fe, Ni, and Zn), lithium titanate, and LiMPO₄ (where M is one or more elements selected from the group consisting of Fe, Mn, Co, and Ni).

The content of the positive electrode active material in the positive electrode material mixture layer is not particularly limited, but is, for example, 50% by mass or more and 99% by mass or less.

The positive electrode material mixture layer may further contain a solid electrolyte. The solid electrolyte is not particularly limited as long as it can conduct lithium ions, and examples thereof include an oxide solid electrolyte and a sulfide solid electrolyte.

The positive electrode material mixture layer may further contain a binder, a conductivity aid, etc.

The method for forming the positive electrode material mixture layer is not particularly limited, and examples thereof include a method of applying a slurry containing a positive electrode active material and a solvent.

The material constituting the positive electrode current collector is not particularly limited, and examples thereof include aluminum, an aluminum alloy, stainless steel, nickel, iron, and titanium. Among these, aluminum, an aluminum alloy, and stainless steel are preferable.

The shape of the positive electrode current collector is not particularly limited, and examples thereof include a foil shape and a plate shape.

Although the embodiments of the present invention have been described above, the present invention is not limited to the above-described embodiments, and the above-described embodiments may be modified as appropriate within the scope of the gist of the present invention. For example, the first elastic member 14A may include the first sealing part 21A and the second sealing part 21B at both end portions, respectively, in the lateral direction (B-B direction) perpendicular to the stacking direction of the battery cells 11.

### EXAMPLES

10 battery module
11 battery cell
11A, 11B battery cell stack
12A, 12B end plate
12C center plate
13A, 13B binding bar
14A first elastic member
14B second elastic member
20 pouch
21A first sealing part
21B second sealing part
21C, 21D third sealing part
21E fourth sealing part
22A first support member
22B second support member
23A, 23B elastic foam body

What is claimed is:

1. A battery module comprising:
a battery cell stack in which a plurality of battery cells are stacked; and
an elastic member disposed between the plurality of battery cells,
the elastic member comprising: a pouch comprising a first sealing part and a second sealing part at both end portions, respectively, thereof in a direction perpendicular to a stacking direction of the battery cells, the pouch having a gas sealed therein; a first support member supporting at least a portion of the first sealing part; and a second support member supporting at least a portion of the second sealing part, and
a ratio of a thickness of the first support member to a thickness of the pouch and a ratio of a thickness of the second support member to the thickness of the pouch being 0.2 or more and 3.5 or less.

2. The battery module according to claim 1, wherein in the direction perpendicular to the stacking direction of the battery cells, a length of the first support member and a length of the second support member are equal to or less than a length of the pouch.

3. The battery module according to claim 1, wherein a seal strength of the first sealing part and a seal strength of the second sealing part are 1 N/mm or more.

4. The battery module according to claim 1, wherein in the first elastic member, a portion of the first sealing part and a portion of the second sealing part face the battery cells.

5. The battery module according to claim 1,
wherein the pouch comprises a third sealing part extending in the direction perpendicular to the stacking direction of the battery cells, and
wherein the third sealing part faces one of the battery cells.

6. The battery module according to claim 5, wherein the third sealing part comprises a resin.

7. The battery module according to claim 5, wherein the third sealing part comprises a metal.

8. The battery module according to claim 1, wherein the first support member and the second support member each comprise a resin.

9. The battery module according to claim 1, wherein the first support member and the second support member each comprise a metal.

10. The battery module according to claim 1, wherein the pouch has an internal pressure of 0.1 MPa or more and 3.0 MPa or less.

11. The battery module according to claim 1, wherein the elastic member further comprises an elastic foam body disposed on each side of the pouch in the stacking direction of the battery cells.

12. The battery module according to claim 1, wherein the battery cells each comprise a cell comprising: a negative electrode material mixture layer comprising lithium metal or a lithium alloy; a solid electrolyte layer; and a positive electrode material mixture layer.
